(19) United States
(12) Patent Application Publication
(10) Pub. No.: US 2009/0016567 A1
(43) Pub. Date: Jan. 15, 2009

(54) Image Display Apparatus, Image Display Method, and Program

(75) Inventors: Seiji AISO, Shiojiri-shi (JP); Kenji MATSUZAKA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/115,397

(22) Filed: May 5, 2008

(30) Foreign Application Priority Data
Jul. 9, 2007 (JP) 2007-179326

(51) Int. Cl. G06K 9/00

(52) U.S. Cl. 382/100

(57) ABSTRACT

An image display apparatus displays a digital image on a confirmation screen. The image display apparatus includes a blur variance value acquisition unit that acquires a blur variance value, which is an index relating to a difference in amount of blur between images obtained when the digital image is printed out and when the digital image is displayed on the confirmation screen, a blur amount variance correction unit that corrects the difference in amount of blur for the digital image displayed on the confirmation screen according to the blur variance value with respect to the digital image printed out, and an image display unit that displays the digital image for which the difference in amount of blur has been corrected on the confirmation screen.

### BACKGROUND

1. Technical Field

The present invention relates to a technique to play back a taken image stored in the form of digital data to be displayed on the monitor screen.

2. Related Art

Advancements in the electronic-related technique, most notably computers, have made it common nowadays to output a taken image as digital data. A large volume of images can be stored electronically by saving images of pictures taken by a digital camera (electronic still camera) in the form of digital data. In addition, the content of an image can be confirmed readily by reading out the digital data to be displayed on the monitor screen.

Under these circumstances, as is disclosed, for example, in JP-A-2006-318165, there has been proposed a technique to print out desired taken pictures alone by allowing the user to confirm the contents (that is, the subject, the composition, the focus, and so forth) of taken images stored in the form of digital data on the monitor screen before he prints out the taken images.

However, confirming taken images on the monitor screen has a limitation, and this limitation poses a problem that properly taken images alone are not necessarily printed out. To be more specific, because a taken image is normally printed out on paper of a size bigger than the monitor screen, there may be a case where the presence of blur in an image resulting from defocusing or hand shaking that was unnoticeable when the image was confirmed on the monitor screen becomes noticeable for the first time when the image is printed out, and the printed image is wasted after all. It is possible to confirm blur or shaking on the monitor screen by displaying as large an image as the print size on the monitor screen. However, because only a part of the taken image is displayed, the user has to make confirmation more than once by changing the displayed area. In addition, in order to confirm the entire subject or the composition, it is still necessary to display the entire taken image on the monitor screen. The advantage achieved by handling the taken images in the form of digital data that the contents of the taken images can be readily confirmed on the monitor screen is thus lessened markedly.

### SUMMARY

An advantage of some aspects of the invention is to provide a technique for enabling the user to choose proper images alone by making it possible to readily confirm images outputted as digital data on the monitor screen.

An image display apparatus according to one aspect of the invention adopts the configuration as follows.

That is, an image display apparatus displays a digital image on a confirmation screen, and includes a blur variance value acquisition unit that acquires a blur variance value, which is an index relating to a difference in amount of blur between images obtained when the digital image is printed out and when the digital image is displayed on the confirmation screen, a blur amount variance correction unit that corrects the difference in amount of blur for the digital image displayed on the confirmation screen according to the blur variance value with respect to the digital image printed out, and an image display unit that displays the digital image for which the difference in amount of blur has been corrected on the confirmation screen.

In addition, an image display method according to another aspect of the invention corresponding to the image display apparatus described above is an image display method for displaying a digital image on a confirmation screen. The method includes acquiring a blur variance value, which is an index relating to a difference in amount of blur between images obtained when the digital image is printed out and when the digital image is displayed on the confirmation screen, correcting the difference in amount of blur for the digital image displayed on the confirmation screen according to the blur variance value with respect to the digital image printed out, and displaying the digital image for which the difference in amount of blur has been corrected on the confirmation screen.

According to the image display apparatus and the image display method according to the aspects of the invention, a blur variance value, which is an index relating to a difference in amount of blur between images obtained when the digital image is printed out and when the digital image is displayed on the confirmation screen, is acquired. Herein, as the blur variance value, any index can be adopted as long as it is an index relating to a difference in amount of blur between the images. For example, a ratio of the size of the confirmation screen and the size of print paper (or the printed image) can be used as the blur variance value. Alternatively, instead of a simple ratio, a value that takes into account a distance from an observer who observes the image to the image can be used as the blur variance value. Further, by quantifying a difference in amount of blur by an experimental method, it is possible to use an amount of blur that reflects, for example, a difference in impression or in vision between the images obtained when the image is printed out and when the image is displayed on the screen. When the blur variance value has been found in the manner described above, the difference in amount of blur is corrected according to the blur variance value, after which the corrected digital image is displayed on the confirmation screen. When the difference in amount of blur is corrected according to the blur variance amount, for example, a two-dimensional filter that is determined according to the blur variance value can be applied to the digital image displayed on the confirmation screen.

It is normal that the digital image displayed on the confirmation screen has an amount of blur different from that in the image obtained when the digital image is printed out. Accordingly, even when the image is confirmed on the confirmation screen, it can happen that a defocused image is printed out wastefully. To eliminate this inconvenience, by displaying the image on the confirmation screen in a state where a correction is made to the difference in amount of blur between images when the image is displayed on the conformation screen and when the image is printed out, the user is able to choose proper images alone. It is thus possible to avoid an image that is actually out of focus from being printed out wastefully. In addition, because hand shaking or the subject shaking can be deemed as a state where blurring is occurring in one direction, it is possible to avoid an image with the hand shaking or the subject shaking from being printed out wastefully.

In order to correct the difference in amount of blur, it is sufficient to correct an amount of blur in the image displayed on the confirmation screen to approximate to an amount of blur in the image obtained when printed out, and amounts of blur in the image displayed on the screen and in the printed image are not necessarily corrected to be equal. It goes without saying, however, that correcting the amounts of blur to be equal is preferable because the user becomes able to confirm the image obtained when it is printed out more appropriately on the confirmation screen.

The image display apparatus according to the aspect of the invention may be configured in such a manner that the digital image is divided into block of a specific size to obtain the blur variance value block by block, so that the difference in amount of blur is corrected by applying a two-dimensional filter corresponding to the blur variance value to the digital image block by block.

Because an amount of blur differs from one position to another in the image, an amount of blur can be corrected more appropriately by dividing the image into blocks and correcting an amount of blur block by block, which in turn makes it possible to display the image appropriately on the confirmation screen.

The image display apparatus according to the aspect of the invention may be configured in such a manner that the difference in amount of blur is corrected using the two-dimensional filter of a larger filter size as the difference in amount of blur becomes larger.

For example, in a case where a given image is to be blurred considerably, the image can be blurred more appropriately or efficiently when a two-dimensional filter of a larger filter size is used. In light of this fact, in a case where a difference in amount of blur between the image displayed on the confirmation screen and the printed image is corrected, the image to be displayed on the confirmation screen can be corrected appropriately or efficiently by using a larger two-dimensional filter as the difference in amount of blur to be corrected becomes larger.

Alternatively, the image display apparatus according to the aspect of the invention may be configured in such a manner that an image size in which the digital image is to be printed out is acquired before the blur variance amount is acquired, so that the blur variance value is acquired according to the image size.

Strictly speaking, an amount of blur when the digital image is printed out depends on the image size. Hence, strictly speaking, the blur variance value, which is an index relating to a difference in amount of blur between images obtained when the digital image is printed out and when the digital image is displayed on the confirmation screen, depends on the image size. Accordingly, by acquiring the image size in advance before the blur variance value is acquired, it is possible to acquire a more precise blur variance value, which makes it possible to display the image in which the amount of blur has been corrected more accurately on the conformation screen.

In this instance, the blur variance value may be acquired in the manner as follows. That is, the blur variance value is pre-stored in correlation with the combination of an amount of blur contained in the digital image and the image size. Accordingly, the pre-stored blur variance value is acquired on the basis of an amount of blur extracted from the digital image and the image size.

By pre-storing the blur variance value correlated with the combination of the amount of blur contained in the digital image and the image size in the manner described above, it is possible to acquire the appropriate blur variance value promptly on the basis of the amount of blur extracted from the digital image and the image size, which makes it possible to display the image on the confirmation screen by correcting the image to be displayed thereon appropriately and promptly.

The image display apparatus according to the aspect of the invention may be configured in such a manner that in a case where an amount of correction for an amount of blur becomes larger than a predetermined amount, the amount of correction for the difference in amount of blur is fixed to this predetermined amount. In this instance, the fixed predetermined value can be a value determined in reference to the size of the confirmation screen.

When an amount of blur in the image displayed on the confirmation screen becomes too large, the user views the magnitude of an amount of blur in relation with the size of the screen rather than the magnitude itself of an amount of blur. Accordingly, by configuring in such a manner that the amount of correction is limited to the predetermined amount in a case where an amount of correction for an amount of blur becomes larger than the predetermined amount, it becomes possible to avoid an amount of blur in the image displayed on the confirmation screen from becoming too large. It is thus possible to display an image in which an amount of blur has been corrected appropriately on the confirmation screen.

Further, according to still another aspect of the invention, a program to execute the image display method described above can be achieved with a computer by reading and running the program on the computer to achieve specific functions. The invention therefore includes an implementation as a program as follows. That is, a program according to still another aspect of the invention corresponding to the image display method described above is a program that is run on a computer to execute a method for displaying a digital image on a confirmation screen. The program causes the computer to achieve a blur variance value acquisition function of acquiring a blur variance value, which is an index relating to a difference in amount of blur between images obtained when the digital image is printed out and when the digital image is displayed on the confirmation screen, a blur amount variance correction function of correcting the difference in amount of blur for the digital image displayed on the confirmation screen according to the blur variance value with respect to the digital image printed out, and an image display function of displaying the digital image for which the difference in amount of blur has been corrected on the confirmation screen.

By reading and running the program on the computer to achieve the respective functions as above, the user is able to choose proper images alone on the confirmation screen. It is thus possible to avoid an image that is actually out of focus from being printed out wastefully.

### BRIEF DESCRIPTION OF THE DRAWINGS

The invention will be described with reference to the accompanying drawings, wherein like numbers reference like elements.

FIG. 1 is a perspective view showing the outward appearance of a printer equipped with an image display apparatus according to one embodiment.

FIG. 2 is a flowchart detailing the flow of finish confirmation processing performed by the printer of the embodiment.

FIG. 3 is a view used to conceptually describe a manner in which a read image is divided into plural blocks.

FIG. 4A through FIG. 4C are views used to describe a manner in which the edges in the image are detected with the use of a Sobel filter.

FIG. 5A and FIG. 5B are views used to describe a manner in which an edge width is detected on the basis of the edges in the horizontal direction and the vertical direction.

FIG. 6 is a view used to describe DCT coefficients stored in image data in JPEG format.

FIG. 7A through FIG. 7C are views used to describe a basic concept of generating a correction filter.

FIG. 8 is a view used to describe the principle to determine an amount of correction for an amount of blur on the basis of the viewing angle of the image.

FIG. 9A and FIG. 5B are views used to describe a manner in which a Gaussian filter is generated on the basis of a filter size.

FIG. 10A and FIG. 10B are views used to describe a manner in which a correction filter used to correct an amount of blur is generated.

FIG. 11 is a view used to conceptually describe a relation between an amount of blur in a saved image and an amount of blur on a monitor screen according to a first modification.

FIG. 12 is a view used to conceptually describe a relation between an amount of blur in an image saved in a recording medium or the like and an amount of blur on the monitor screen according to a second modification.

### DESCRIPTION OF EXEMPLARY EMBODIMENTS

For clear understating of the contents of the invention, embodiments will be described regarding the points and in the order as follows: the configuration of apparatus, finish confirmation processing, a first modification, and a second modification.

### The Configuration of Apparatus

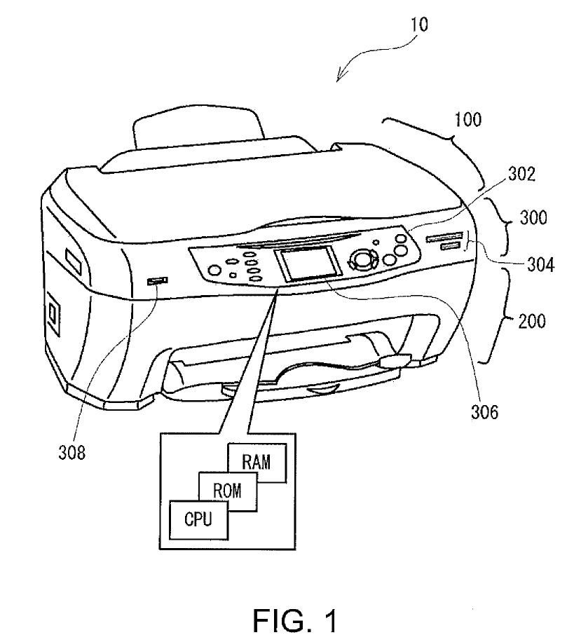

FIG. 1 is a perspective view showing the outward appearance of a printer 10 equipped with an image display apparatus according to one embodiment. As is shown in the drawing, the printer 10 of the embodiment includes a scanner unit 100, a printer unit 200, and a control unit 300 that controls operations of the scanner unit 100 and the printer unit 200. The scanner unit 100 is furnished with the scanner capability of reading a printed image and generating image data thereof. The printer unit 200 is furnished with the printer capability of receiving the image data and printing the image on a print medium.

The control unit 300 has on board an operation panel 302 used by the user when he operates the printer 10, a loading slot 304 to insert an external memory medium, such as a memory card, a USB terminal 308 to enable data reception and transmission with an external device, and so forth. Also, the control unit 300 incorporates therein a CPU, a ROM, a RAM, and so forth. The user of the printer 10 inserts a memory medium in which are stored images taken by a digital camera or the like into the loading slot 304 and chooses images while he confirms the images on a monitor screen 306 provided to the operation panel 302. Then, the images thus chosen are printed out in the printer unit 200. Also, by connecting a digital camera to the printer 10 via the USB terminal 308, the user becomes able to choose images stored in the digital camera while confirming the images on the monitor screen 306 so that the chosen images are printed out in the printer unit 200.

It should be noted that the size of the monitor screen 306 is different from the size of an image obtained by printing, and normally the monitor screen 306 is smaller than the print image. Accordingly, because an image to be printed out is displayed on the monitor screen 306 in a scaled-down state, it can happen that an image that looked well-focused when confirmed on the monitor screen 306 is out of focus when actually printed out. Likewise, it can happen that a printed image is wasted because hand shaking or motion blur of the subject that was unnoticeable when confirmed on the monitor screen 306 becomes noticeable when actually printed out. Enlarging a part of the image displayed on the monitor screen 306 with the aim of avoiding such inconveniences makes it difficult to confirm the entire image. In addition, because the allowable degree of blur or shaking can actually vary from one part to another in the image, it is necessary to view the entire image by also taking the degree of blur or shaking into account, which is, however, difficult to achieve with the small monitor screen 306. To overcome such inconveniences, the printer 10 of the embodiment displays an image as described below for enabling the user to view the entire image by taking the degree of blur or shaking into account even on the monitor screen 306.

### Finish Confirmation Processing

The printer 10 of the embodiment is configured in such a manner that when images stored in a recording medium or a digital camera are read out and displayed on the monitor screen 306 and the user finds an image he wishes to be printed out, finish confirmation processing described below is started when he presses a specific button on the operation panel 302 while this image is being chosen. This configuration enables the user to confirm an image that will be actually obtained in print on the monitor screen 306.

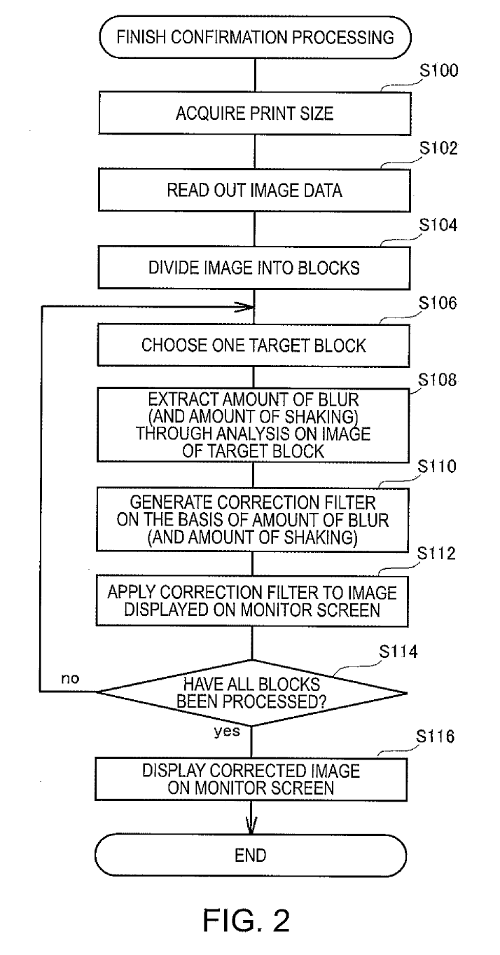

FIG. 2 shows a flowchart detailing the flow of the finish confirmation processing performed by the printer 10 of the embodiment. This processing is processing performed by the CPU, the ROM, the RAM, and so forth incorporated in the control unit 300.

When the finish confirmation processing is started, print size in which the image is to be printed out (for example, whether the image is to be printed on L-size paper or A4-size paper) is acquired first (Step S100). The print size in which an image is to be printed out may be pre-set in the printer 10 so that the setting content thereof is acquired at the time of printing, or the user may be requested to input the desired print size.

Subsequently, processing to read out image data corresponding to the image being displayed on the monitor screen 306 from a recording medium or a digital camera is performed (Step S102). More specifically, because the monitor screen 306 has a small screen size and the screen is formed of a matrix of fewer pixels, the stored image data is displayed in a resolution-converted state, for example, by skipping some pixels. Accordingly, not the resolution-converted image data being displayed on the monitor screen 306 but the image data saved in the storage medium or the digital camera is read out.

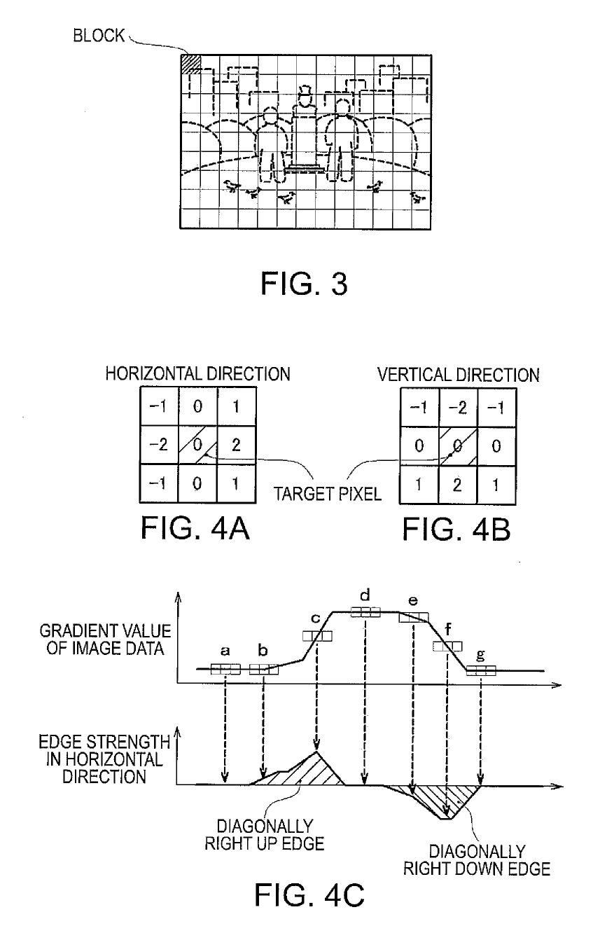

The image thus read is then divided into plural blocks (Step S104). FIG. 3 is a view used to conceptually describe a manner in which the read image is divided into plural blocks. Subsequent processing will be performed block by block.

Initially, one block (target block) as a block to be processed is chosen (Step S106). In FIG. 3, the block being chosen is indicated by shading. Subsequently, an amount of blur (and an amount of shaking) is extracted through analysis on the image data of the target block (Step S108). In other words, an amount of blur caused by defocusing or an amount of shaking caused by hand shaking in the saved image data is extracted block by block. An amount of blur (or an amount of shaking) can be extracted by various methods, and the simplest method is to detect the edges by applying a two-dimensional filter, such as a Sobel filter, to the image data for extracting the amount of blur (or the amount of shaking) on the basis of the detection result.

FIG. 4A through FIG. 4C are views used to describe a manner in which the edges in the image are detected with the use of a Sobel filter. FIG. 4A shows an example of a Sobel filter to detect the edge in the horizontal direction, and FIG. 4B shows an example of a Sobel filter to detect the edge in the vertical direction. The Sobel filter is a two-dimensional filter to find a new gradient value of a target pixel by multiplying the gradient values of the neighboring pixels about the target pixel by specific weight coefficients and adding up the products.

FIG. 4C shows the principle that enables the detection of an edge in the horizontal direction by applying a Sobel filter in the horizontal direction. Assume that a Sobel filter in the horizontal direction is applied to the image data whose gradient value varies as is indicated by a polygonal line on the top row in FIG. 4C. Rectangles indicated by thin lines in FIG. 4C schematically represent a Sobel filter. When the Sobel filter is at the position “a” (that is, at a position where the gradient value does not vary), a weighted value of the pixel in front of the center of the Sobel filter and a weighted value of the pixel in rear of the center are cancelled each other out. Hence, the output value of the Sobel filter (that is, the edge strength) is almost “0”. On the contrary, at the position “b” where the front side of the Sobel filter comes across the edge, the edge strength takes a positive value, and at the position “c” where the entire Sobel filter is encompassed in the edge, the edge strength increases. Also, in the case of a diagonally right down edge as at the position “e”, the edge strength takes a negative value. The polygonal line shown in the bottom row in FIG. 4C indicates the edge strength obtained through application of the Sobel filter as described above. It is therefore understood that by applying the Sobel filter as shown in FIG. 4A, the edge strength can be detected as a positive value for a diagonally right up edge and as a negative value for a diagonally right down edge. Likewise, it is understood that an edge in the vertical direction can be detected with the use of the Sobel filter shown in FIG. 4B, and an edge whose gradient value becomes larger in the lower part is detected as a positive value and an edge whose gradient value becomes smaller in the lower part is detected as a negative value. After the edges in both the horizontal direction and the vertical direction are detected, the edge width is calculated by synthesizing the detection results.

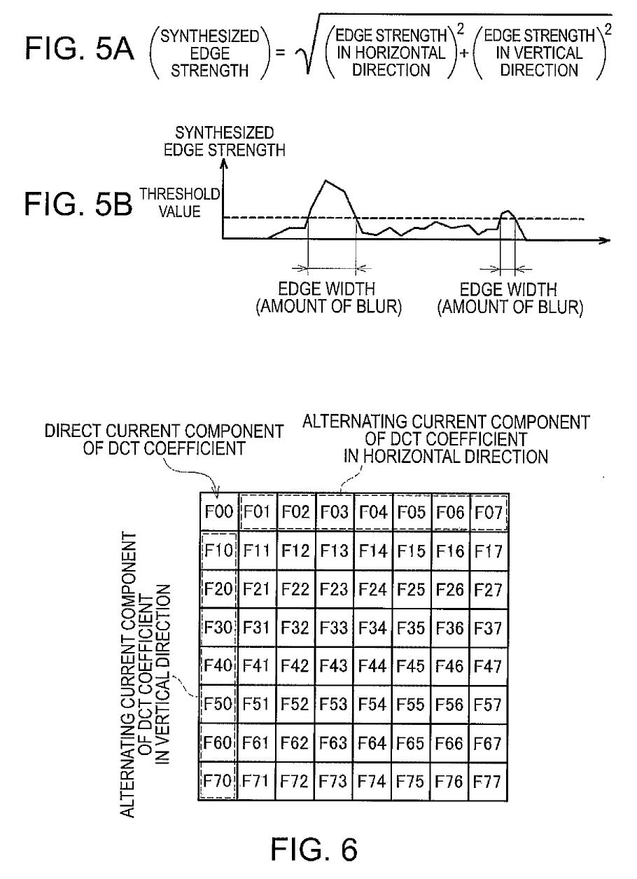

FIG. 5A and FIG. 5B are views used to describe a manner in which the edge width is detected on the basis of the edges in the horizontal direction and the vertical direction. FIG. 5A shows a calculating formula to synthesize the edge strengths in the horizontal direction and the vertical direction. FIG. 5B shows an example of the edge strength obtained through synthesis. As is shown in FIG. 4C, the edge strength obtained with the use of the Sobel filter can take either a positive value or a negative value. However, the synthesized edge strength unexceptionally takes a positive value as is shown in FIG. 5B. Hence, the edge width can be extracted by comparing the synthesized edge strength with a specific threshold value to detect the number of pixels over which the edge strength continuously exceeds the threshold value.

In an image taken by a digital camera, because the edge occurs along the contour of an object and the gradient value varies abruptly at such an edge, the edge width in nature should take an extremely small value. In light of the foregoing, the edge width obtained as described above can be deemed as directly indicating an amount of blur in the image. Also, because hand shaking can be deemed as blur with a directional property, it is possible to extract an amount of shaking in the same manner as above. Processing to extract an amount of blur (and an amount of shaking) in the target block chosen earlier is performed as described above in Step S108 detailed in FIG. 2.

The method for extracting an amount of blur (and an amount of shaking) of the target block is not limited to a method using the Sobel filter as described above, and any other suitable method can be used as well. For example, the image data in a digital camera is normally saved in the format called JPEG. According to JPEG format, image data is divided into a matrix of blocks each having a specific number of pixels (normally 8 pixels), and the image data of each block is separated into a direct current component and alternating current components at respective frequencies. By cutting high frequency components having a little influence on the image quality, it becomes possible to save a compressed image. The alternating current components of the image can be in the horizontal direction or the vertical direction or a direction as the combination thereof. Consequently, coefficients (DCT coefficients) of the respective components when the image data is disassembled into the direct current component and the various alternating current components are saved in the JPEG format.

FIG. 6 is a view used to describe DCT coefficients stored in the image data in JPEG format. As is shown in the drawing, in a case where the image data is stored in JPEG format, DCT coefficients in the horizontal direction and the vertical direction can be read out immediately and the edge widths in the horizontal direction and the vertical direction can be found through analysis on the read DCT coefficients. It is therefore possible to extract the edge width by synthesizing these edge widths.

When an amount of blur (and an amount of shaking) of the target block has been extracted as described above (Step S108 in FIG. 2), a correction filter is generated on the basis of the amount of blur (and the amount of shaking) thus extracted (Step S110). The correction filter referred to herein is defined as follows. That is, because the monitor screen 306 equipped to the printer 10 is not so large, image data saved in a recording medium or a digital camera is displayed on the monitor screen 306 in a scaled-down state. Consequently, blur or hand shaking in the image is scaled down as well, and the degree of blur or hand shaking looks different between the image displayed on the monitor screen 306 and an image actually printed out. The correction filter is a two-dimensional filter used to correct such a difference in vision. By applying the correction filter to the image displayed on the monitor screen 306, it is possible to correct an amount of blur or an amount of shaking in such a manner that blur or shaking becomes equal to blur or shaking in an actually printed out image. Such a correction filter can be generated as follows.

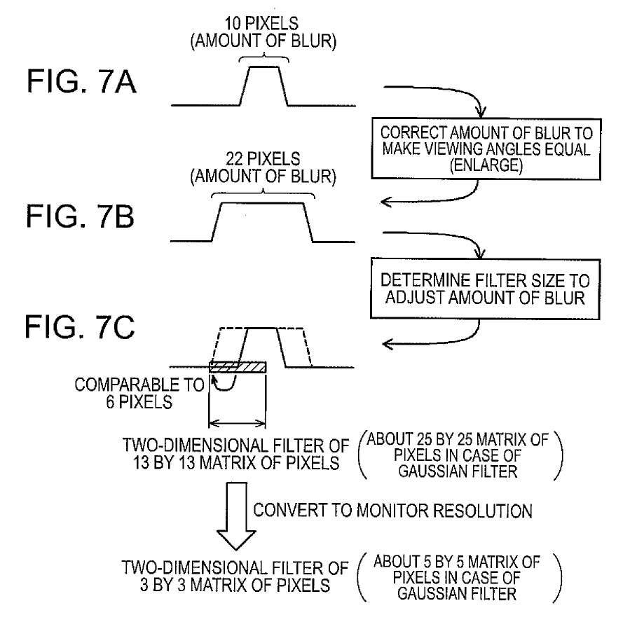

FIG. 7A through FIG. 7C are views used to describe a basic concept of generating the correction filter. For example, assume that an amount of blur (the edge width described above) extracted from the target block is 10 pixels. When the image will be displayed directly on the monitor screen 306 with this amount of blur, the pixels are skipped before it is displayed on the monitor screen 306 or the image is displayed in a scaled-down state. Accordingly, the degree of blur becomes different from that in an actually printed image. To eliminate this inconvenience, the amount of blur is corrected. The degree of correction can be determined by taking the viewing angle of the image into account as will be described in the following.

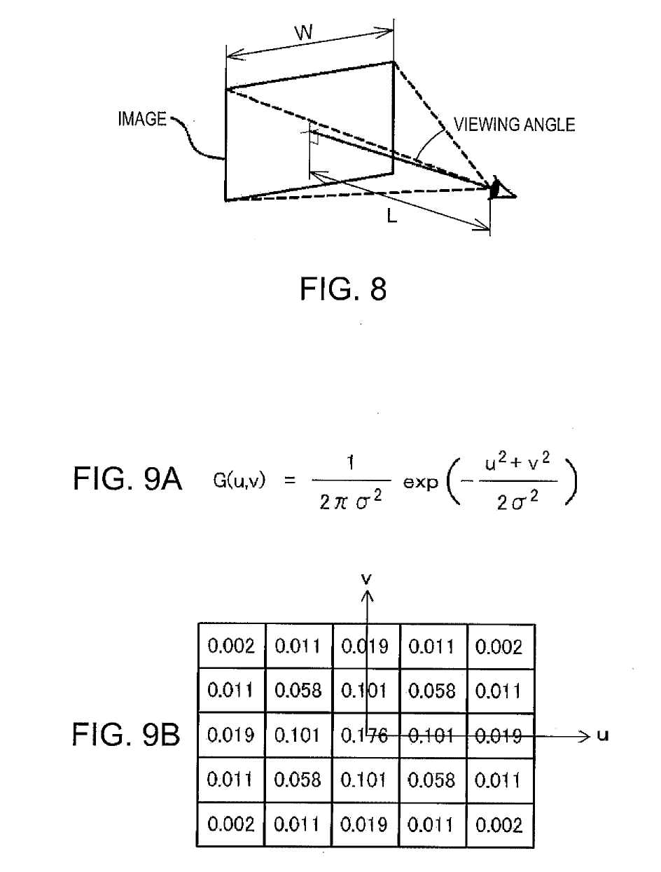

FIG. 8 is a view used to describe the principle to determine an amount of correction for an amount of blur on the basis of the viewing angle of the image. Even when images are of the completely same size, the one placed distant looks smaller and the one placed nearby looks larger. It is obvious from this fact that the size of an image to be observed is generally determined by the actual size of the image and a distance to the image. In other words, by configuring in such a manner that the viewing angles determined by the size W of the image and the distance L to the image when the image is observed are made equal, it is thought that images are viewed in about the same size. In light of this phenomenon, it is possible to predict whether the image on the monitor screen 306 looks larger or smaller than an image to be printed out, and in the case where it looks smaller, it is possible to estimate the extent to which the image looks smaller. Let W be the size of the image and L be the distance to the image when the image is observed, then the viewing angle can be calculated by a mathematical formula as follows:

Viewing angle [deg]=(360/π)arctan(W/2L).

For example, assume that the size W of the monitor screen 306 equipped to the printer 10 is 70 mm and the distance L when the monitor screen 306 is observed is 500 mm, then the viewing angle of the monitor screen 306 is about 8 deg. In a case where the print size is set to the so-called L size, it is assumed that the size W of a printed image is about 90 mm and the distance L to the image when the printed image is confirmed is 300 mm. Then, the viewing angle of the printed image is about 17.2 deg. Consequently, in comparison with a case where the image is printed on L-size paper, the image is displayed on the monitor screen 306 in a state where it is scaled down to about 1/2.2. Conversely, by displaying the image on the monitor screen 306 by increasing an amount of blur extracted from the target block by 2.2 times, it is thought that the image can be displayed with blur (or shaking) at the degree same as the degree when printed on L-size paper.

Hence, in a case where an amount of blur detected from the target block is 10 pixels as shown in FIG. 7A, the image is blurred using the two-dimensional filter so that an amount of blur is increased to 22 pixels as shown in FIG. 7B. In this case, because it is sufficient to spread an amount of blur comparable to 10 pixels to 22 pixels, it is understood that a two-dimensional filter that spreads the information of a given pixel over 6 pixels ahead has to be applied. Various filters are available as such a two-dimensional filter. For example, when the result obtained by applying the filter to a source image is to be written into a destination image, in order to spread information over the 6 pixels ahead, a two-dimensional filter of a size of at least an 11 by 11 to 13 by 13 matrix of pixels is necessary. Further, in a case where a Gaussian filter capable of achieving natural blurring is used, a filter of a size about two time larger is necessary, that is, a filter size of an about 25 by 25 matrix of pixels is necessary. Using a two-dimensional filter of such a size makes it possible to blur the image in such a manner that an amount of blur comparable to 10 pixels is adjusted to an amount of blur comparable to 22 pixels.

As has been described, the finish confirmation processing detailed in FIG. 2 is the processing that is started when the specific button on the operation panel 302 is pressed by the user who particularly wishes to conform the finishing of a printed image while the image is displayed on the monitor screen 306. In other words, because an image whose resolution is converted to the resolution of the monitor screen 306 is present, the filter is not applied to the image read out from a recording medium or a digital camera but the filter is applied to the image having undergone the resolution conversion processing according to the monitor screen 306. Accordingly, a filter used to blur the image is also a filter of a resolution-converted size.

For example, assume that an image saved in a recording medium is composed of 2000 pixels in the width direction while the monitor screen 306 is formed of 320 pixels in the width direction. Then, in order to display the image saved in the recording medium on the monitor screen 306, 2000 pixels are subjected to resolution conversion to 320 pixels. Accordingly, in the case of a two-dimensional filter of a 13 by 13 matrix of pixels, we get 320*13/2000=2.08. Hence, it is sufficient to use a filter of a 2 by 2 matrix of pixels (in practice, because the filter size takes an odd number, a 3 by 3 matrix of pixels). In the case of a Gaussian filter of a 25 by 25 matrix of pixels, we get 320*25/2000=4. Because the filter size takes an odd number, it is sufficient to use a Gaussian filter of a 5 by 5 matrix of pixels. In this manner, once the filter size is determined, the correction filter can be readily generated.

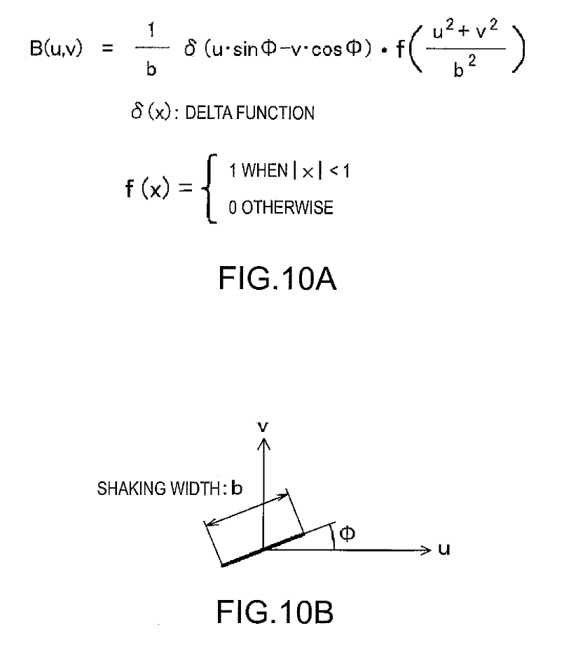

FIG. 9A and FIG. 9B are views used to describe a manner in which a Gaussian filter is generated on the basis of the filter size. Herein, C shown in the drawing indicates the half width of the number of pixels to be blurred. In the example described above, 12 pixels are to be blurred in a state at the resolution saved in the recording medium. Hence, at the resolution of the monitor screen 306, it is the half of about 1.9 pixels (=320*12/2000), which is about 0.95. Regarding the correction filter used to correct the amount of shaking, once the filter size is determined, it is possible to generate the correction filter in accordance with Equation shown in FIG. 10A, where b is the shaking width at the resolution of the monitor screen 306 and θ is the direction of shaking as are shown in FIG. 10B. In Step S110 detailed in FIG. 2, the correction filter at the resolution of the monitor screen 306 is generated in the manner described above.

Subsequently, the correction filter thus generated is applied to the image being displayed on the monitor screen 306 (Step S112), and whether all the blocks have been processed is determined (Step S114). In a case where there are blocks that have not been processed (Step S114: no), the flow returns to Step S106 and one new target block is chosen to apply the processing described above to this new target block. This operation is performed repetitively until it is determined that all the blocks have been processed (Step S114: yes). Then, the image to which the correction filter has been applied is displayed on the monitor screen 306 (Step S116), after which the finish confirmation processing detailed in FIG. 2 is terminated.

The printer 10 of the embodiment described above is capable of displaying an image on the monitor screen 306 with an amount of blur (and an amount of shaking) at about the same degree as blur (or shaking) in an actually printed image by performing the finish confirmation processing detailed in FIG. 2. Hence, because the user is able to confirm to which extent the image is blurred (or shaken) on the monitor screen 306 without having to actually print out the image, it is possible to avoid the image from being printed out wastefully.

Strictly speaking, blur or shaking is inevitably present somewhere across the entire image, and merely whether the degree of blur or shaking is allowable is concerned. Also, because whether blur or shaking is allowable closely relates to the subject or the composition, it is difficult to make a determination unless the entire image is viewed. In this regard, the finish confirmation processing described above enables the user to confirm the degree of blur or the degree of shaking in each part of the image while the entire image is being displayed on the monitor screen 306. Accordingly, the user is able to determine appropriately whether the degree of blur or shaking is allowable without having to actually print out the image. It is thus possible to avoid in a reliable manner such an event that an image with considerable blur or shaking at unallowable degree is printed out wastefully.

### Modifications

The embodiment described above can be modified in various manners. Hereinafter, such modifications will be briefly described.

### First Modification

In the embodiment described above, when an amount of blur in the image saved in a recording medium or a digital camera is extracted, how many pixels should be blurred is determined by multiplying an amount of blur by a proportional coefficient depending on the difference in viewing angle between images. Accordingly, more pixels have to be blurred as an amount of blur in the original image increases.

However, when an amount of blur in the image displayed on the monitor screen 306 is increased to the extent that it can be compared with the monitor screen 306 (for example, about 1/10 of the monitor screen 306), an amount of blur (or an amount of shaking) is confirmed by comparison with the size of the monitor screen 306. Consequently, although an amount of blur itself on the monitor screen 306 is about the same as an amount of blur in an actually printed image, the former seems larger than the actual amount of blur due to the comparison with the monitor screen 306.

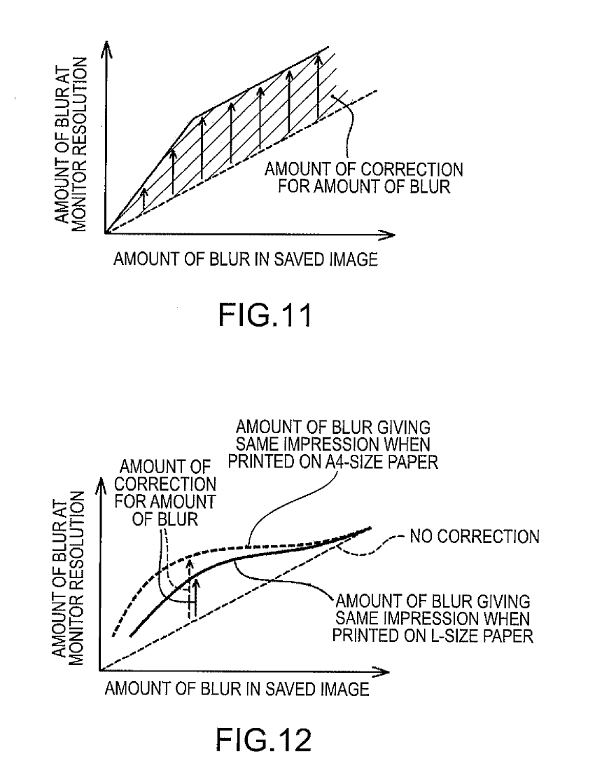

To avoid such an inconvenience, in a case where an amount of blur in a saved image reaches or exceeds a specific value (or in a case where an amount of blur on the monitor screen 306 reaches or exceeds a specific value), an amount of blur on the monitor screen 306 may be corrected by a predetermined amount regardless of the amount of blur in the saved image. FIG. 11 conceptually shows a relation between an amount of blur in a saved image and an amount of blur on the monitor screen according to the first modification as described above. As is shown in the drawing, the first modification is configured in such a manner that in a case where an amount of blur in the image on the monitor screen 306 becomes larger than a certain value, it is corrected by a predetermined amount even when an amount of blur in the saved image has increased. When configured in this manner, even when an amount of blur on the monitor screen 306 has increased considerably, it is still possible to display on the monitor screen 306 an image that gives an impression same as the impression given from an actually printed image.

### Second Modification

In the embodiment described above, when an amount of blur in a saved image is extracted, an amount of blur on the monitor screen 306 is calculated to make the viewing angles equal, after which the filter size is determined to achieve the amount of blur thus calculated. However, instead of calculating an amount of blur on the monitor screen 306 on the basis of the viewing angles, an amount of blur on the monitor screen 306 may be found by actually conducting a sensory test.

FIG. 12 is a view used to conceptually describe a relation between an amount of blur in an image saved in a recording medium or the like and an amount of blur on the monitor screen 306 according to a second modification. In the drawing, a thick line represents the result found by a sensory test conducted by varying an amount of blur in the image as to how many pixels should be blurred on the monitor screen 306 to let the image look as blur as a printed image in a case where the image is printed on L-size paper. A thick broken line in the drawing represents the result found by conducting a similar sensory test in a case where the image is printed on A4-size paper. An amount of correction for an amount of blur on the monitor screen 306 and hence the filter size of the correction filter can be determined by finding such a correlation in advance.

Also, in this case, instead of the correlation shown in FIG. 12, that is, the correlation between an amount of blur in the saved image and an amount of blur on the monitor screen 306, a correlation between an amount of blur in the saved image and the filter size of the correction filter may be found in advance. When configured in this manner, once the print size and an amount of blur in the saved image are known, the filter size of the correction filter can be determined immediately. It is thus possible to update the image on the monitor screen 306 swiftly by generating the correction filter quickly.

While the image display apparatus has been described by way of the embodiment and modifications thereof, the invention is not limited to these embodiment and modifications, and can be practiced in various manners without deviating from the scope of the invention.

The entire disclosure of Japanese Patent Application No. 2007-179326, filed Jul. 9, 2007 is expressly incorporated by reference herein.

What is claimed is:

1. An image display apparatus that displays a digital image on a confirmation screen, comprising:
a blur variance value acquisition unit that acquires a blur variance value, which is an index relating to a difference in amount of blur between images obtained when the digital image is printed out and when the digital image is displayed on the confirmation screen;
a blur amount variance correction unit that corrects the difference in amount of blur for the digital image displayed on the confirmation screen according to the blur variance value with respect to the digital image printed out; and
an image display unit that displays the digital image for which the difference in amount of blur has been corrected on the confirmation screen.

2. The image display apparatus according to claim 1, further comprising:
an image dividing unit that divides the digital image into blocks of a specific size,
wherein:
the blur variance value acquisition unit is a unit that acquires the blur variance value block by block; and
the blur amount variance correction unit is a unit that corrects the difference in amount of blur by applying a two-dimensional filter corresponding to the blur variance value to the digital image block by block.

3. The image display apparatus according to claim 1, wherein:
the blur amount variance correction unit is a unit that corrects the difference in amount of blur by using a two-dimensional filter of a larger filter size as the difference in amount of blur becomes larger.

4. The image display apparatus according to claim 1, further comprising:
an image size acquisition unit that acquires an image size in which the digital image is to be printed out,
wherein the blur variance value acquisition unit is a unit that acquires the blur variance value according to the image size.

5. The image display apparatus according to claim 4, further comprising:
a blur variance value storage unit that pre-stores the blur variance value in correlation with a combination of the amount of blur contained in the digital image and the image size,
wherein the blur variance value acquisition unit is a unit that acquires the blur variance value on the basis of the amount of blur contained in the digital image and the image size.

6. The image display apparatus according to claim 1, wherein:
the blur amount variance correction unit is a unit that corrects the difference in amount of blur by a predetermined amount in a case where the amount of correction for the amount of blur becomes larger than the predetermined amount.

7. An image display method for displaying a digital image on a confirmation screen, comprising:
acquiring a blur variance value, which is an index relating to a difference in amount of blur between images obtained when the digital image is printed out and when the digital image is displayed on the confirmation screen;
correcting the difference in amount of blur for the digital image displayed on the confirmation screen according to the blur variance value with respect to the digital image printed out; and
displaying the digital image for which the difference in amount of blur has been corrected on the confirmation screen.

8. A program that is run on a computer to execute a method for displaying a digital image on a confirmation screen, the program causing the computer to achieve:
a blur variance value acquisition function of acquiring a blur variance value, which is an index relating to a difference in amount of blur between images obtained when the digital image is printed out and when the digital image is displayed on the confirmation screen;
a blur amount variance correction function of correcting the difference in amount of blur for the digital image displayed on the confirmation screen according to the blur variance value with respect to the digital image printed out; and
an image display function of displaying the digital image for which the difference in amount of blur has been corrected on the confirmation screen.
